(19) United States
(12) Patent Application Publication
(10) Pub. No.: US 2026/0187980 A1
(43) Pub. Date: Jul. 2, 2026

(54) METHOD AND SYSTEM FOR EXPLAINABLE CLASSIFICATION OF A TARGET POINT CLOUD

(71) Applicant: TECHNION RESEARCH & DEVELOPMENT FOUNDATION LIMITED, Haifa (IL)

(72) Inventors: Guy GILBOA, Haifa (IL); Elnatan KADAR, Haifa (IL); Meir Yossef LEVI, Haifa (IL)

(21) Appl. No.: 19/434,466

(22) Filed: Dec. 29, 2025

Related U.S. Application Data
(60) Provisional application No. 63/739,574, filed on Dec. 29, 2024.

(51) Int. Cl. G06V 10/764; G06V 10/24; G06V 10/42; G06V 10/74; G06V 10/778; G06V 10/80

(52) U.S. Cl. CPC G06V 10/764; G06V 10/242; G06V 10/42; G06V 10/761; G06V 10/7784; G06V 10/806

(57) ABSTRACT

A method and system for explainable classification of a target point cloud may include receiving a target point cloud comprising N points in a multidimensional space, applying a feature extraction model to extract, for each point, a permutation-invariant feature vector comprising local feature entries, applying a bottleneck function on the feature vectors to produce a global feature vector having F global feature entries, applying a classification model on the global feature vector to classify the target point cloud according to classification criteria, for one or more points, applying an aggregation function over the local feature entries of the respective feature vector, prior to the bottleneck function, to obtain an aggregation value, and indicating importance of the points in the classification based on their aggregation values.

### CROSS-REFERENCE TO RELATED APPLICATIONS

This application claims the benefit of priority of U.S. Application No. 63/739,574, titled “METHOD AND SYSTEM FOR EXPLAINABLE IMAGE CLASSIFICATION”, filed Dec. 29, 2024, which is hereby incorporated by reference in its entirety.

### FIELD OF INVENTION

The present invention relates generally to data analysis based on Artificial Intelligence (AI). More specifically, the present invention relates to explainability of point-cloud network classification.

### BACKGROUND

Ranking the importance of points within a point cloud may be beneficial for gaining deeper understanding and for improving network performance in various tasks. Being able to compute importance fast, without resorting to gradient computations, can be of great advantage, as it may facilitate use at inference, providing additional capabilities for the network. However, currently available explainable Artificial Intelligence (XAI) methods for point clouds may be slow since they either compute gradients or are based on time-consuming iterative processes. Additionally, common pooling bottleneck architectures, and specifically Max-Pooling, may introduce challenges for gradient-based methods. Importance may become non-smooth, with either extreme values or flat areas, such that high quality ranking may be difficult to obtain.

Currently available methods for point cloud explainability employ various techniques and processes, to obtain insight regarding prominence, or significance of specific points in downstream classification or analysis of a given, target point cloud. Following are several examples for such, currently available methods.

Point-Cloud Saliency Maps, which are adapted to Slide points of a given point cloud in relation to the point cloud's center of mass, to estimate their influence on the outcome classification. Such methods typically consider the center region of the point clous as non-influential, which may not always be accurate.

Point-Lime is an adaptation of the Local Interpretable Model-agnostic Explanations (LIME) algorithm for 3-dimensional (3D) point clouds. It is known to be slow, due to the iterative process required for explanation.

PointHop provides a dedicated, learnable network, specifically designed for explainability in point clouds. As known in the art, PointHop is focused on developing new interpretable networks rather than explaining existing ones, thereby incurring a large computational overhead.

Gradient based methods employ calculation of feature gradients, to determine the importance of points in the original point cloud. It may be appreciated that such calculations are computationally intensive, leading to slow throughput. Additionally, the quality of explanations may be inadequate and non-smooth.

“Critical Points” (CP) identifies a set of active points after a final pooling layer in the network. As explained herein, post-pooling (also referred to herein a post-bottleneck) measures are typically non-smooth, and provide poor-quality ranking of importance.

Perturbation based methods evaluate an impact of a systematic change, applied to the input point cloud (e.g., removing or altering points in the point cloud) on the output. As explained herein, such method are also computationally intensive and time-consuming.

In summary, current methods for point-cloud explainability face limitations such as being slow, computationally intensive, and providing non-smooth or inadequate explanations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

As elaborated herein, embodiments of the invention may include a method of explainable classification of a target point cloud by at least one processor. This method is referred to herein as a “Feature-Based Interpretability” (FBI) method, and may be configured to address the above-explained limitations by offering efficient, high-quality, and scalable approach for point-cloud explainability.

According to some embodiments, at least one processor may be configured to receive a target point cloud including a plurality N of points in a multidimensional space. The processor may be further configured to apply a feature extraction model on the target point cloud to extract, for each point of the N points, a respective permutation-invariant feature vector including a plurality of local feature entries. The processor may also be configured to apply a bottleneck function on the permutation-invariant feature vectors of the N points to produce a global feature vector having a plurality F of global feature entries. Additionally, the processor may be configured to apply a classification model on the global feature vector to classify the target point cloud according to one or more classification criteria. The processor may be further configured to, for one or more points of the N points, apply an aggregation function over the local feature entries of the respective permutation-invariant feature vector, prior to the bottleneck function, to obtain a respective aggregation value. The processor may also be configured to indicate importance of the one or more points in said classification based on their respective aggregation values.

According to some embodiments, a total number of local feature entries across the N points may exceed the number of global feature entries F by at least one order of magnitude.

According to some embodiments, the bottleneck function may include a pooling function that aggregates the permutation-invariant feature vectors across the N points along a points dimension to produce the global feature vector.

According to some embodiments, the pooling function may be selected from a list consisting of: (i) a maximum pooling function, (ii) a mean pooling function, and a combination thereof.

According to some embodiments, the bottleneck function may be further selected from (iii) a weighted pooling function applied on values of corresponding local feature entries of the permutation-invariant feature vectors, (iv) a dense artificial Neural Network (NN) bottleneck layer applied on the permutation-invariant feature vectors, (v) a NN convolutional layer applied on the permutation-invariant feature vectors, and any combination thereof.

According to some embodiments, applying the aggregation function of a specific point of the N points may include at least one of: (i) summing local feature entries of that point, (ii) summing absolute values of local feature entries of that point, (iii) performing a weighted sum of local feature entries of that point, (iv) applying a predetermined function on a majority of local feature entries of that point, and any combination thereof.

According to some embodiments, indicating importance of the one or more points may include at least one of: (i) ranking the one or more points according to their respective aggregation values; (ii) generating an influence map associating each of the one or more points with a respective aggregation value; (iii) identifying a subset of points having aggregation values above a predetermined threshold as high-importance points; (iv) providing a visualization of the target point cloud wherein the one or more points may be visually distinguished based on their respective aggregation values; (v) providing online feedback during inference of the classification model based on the respective aggregation values, and any combination thereof.

According to some embodiments, the processor may be further configured to apply a rotation transformation to the target point cloud to produce a rotated point cloud. The processor may be configured to, for one or more points of the N points: (a) apply the feature extraction model on the rotated point cloud to extract a respective rotated permutation-invariant feature vector having a plurality of local feature entries, (b) apply the aggregation function over the local feature entries of the respective rotated permutation-invariant feature vector, prior to the bottleneck function, to obtain a respective rotated aggregation value, and (c) compute a pointwise deviation measure based on a difference between the respective aggregation value and the respective rotated aggregation value. The processor may also be configured to provide a qualitative indication of rotation invariance of the feature extraction model and/or classification model based on the pointwise deviation measure.

According to some embodiments, the processor may be further configured to calculate a shape deviation measure based on pointwise deviation measures of the one or more points of the target point cloud. Additionally or alternatively, the processor may be configured to, based on the shape deviation measure, provide feedback for retraining the classification model and/or the feature extraction model, so as to improve rotation invariance.

According to some embodiments, the processor may be further configured to identify a set of outlier points within the target point cloud, wherein the outlier points may be out-of-distribution (OOD) points not present during training of the feature extraction model. The processor may be configured to compute an OOD influence measure as a ratio of a sum of aggregation values of the outlier points to a sum of aggregation values of all points in the target point cloud. The processor may also be configured to provide a qualitative indication of OOD robustness of the feature extraction model and/or classification model based on the OOD influence measure, wherein a higher OOD influence measure may be indicative of lower OOD robustness.

According to some embodiments, the processor may be further configured to compare the OOD influence measure to a predetermined threshold. Additionally, or alternatively, the processor may be configured to, based on the comparison, provide feedback for retraining the feature extraction model and/or classification model to reduce influence allocated to outlier points, so as to improve OOD robustness.

According to some embodiments, the processor may be further configured to identify a geometric symmetry property of the target point cloud. The processor may be configured to analyze a distribution of the aggregation values across the target point cloud to determine a symmetry influence measure. The processor may also be configured to compare the symmetry influence measure to the geometric symmetry property. Additionally, the processor may be configured to provide a qualitative indication of dataset bias in training data used to train the feature extraction model and/or classification model based on the comparison.

According to some embodiments, the processor may be further configured to, based on the qualitative indication of dataset bias, provide feedback for retraining the feature extraction model and/or classification model using at least one of: (i) a self-supervised learning approach, (ii) augmented training data, and any combination thereof, so as to reduce susceptibility to dataset bias.

According to some embodiments, a method of analyzing rotation invariance of a point-cloud classification network by at least one processor may be provided. The processor may be configured to receive a target point cloud comprising a plurality N of points in a multidimensional space. The processor may be further configured to apply a feature extraction model on the target point cloud to extract, for each point of the N points, a respective permutation-invariant feature vector comprising a plurality of local feature entries. The processor may be configured to, for one or more points of the N points, apply an aggregation function over the local feature entries of the respective permutation-invariant feature vector to obtain a respective aggregation value. The processor may also be configured to apply a rotation transformation to the target point cloud to produce a rotated point cloud. The processor may be further configured to, for the one or more points, apply the feature extraction model on the rotated point cloud and apply the aggregation function to obtain a respective rotated aggregation value. Additionally, the processor may be configured to compute a pointwise deviation measure based on a difference between the respective aggregation value and the respective rotated aggregation value. The processor may also be configured to provide a qualitative indication of rotation invariance of the feature extraction model based on the pointwise deviation measure.

According to some embodiments, a method of analyzing out-of-distribution (OOD) robustness of a point-cloud classification network by at least one processor may be provided. The processor may be configured to receive a target point cloud comprising a plurality N of points in a multidimensional space. The processor may be further configured to apply a feature extraction model on the target point cloud to extract, for each point of the N points, a respective permutation-invariant feature vector comprising a plurality of local feature entries. The processor may be configured to, for one or more points of the N points, apply an aggregation function over the local feature entries of the respective permutation-invariant feature vector to obtain a respective aggregation value. The processor may also be configured to identify a set of outlier points within the target point cloud, wherein the outlier points are OOD points not present during training of the feature extraction model. The processor may be further configured to compute an OOD influence measure as a ratio of a sum of aggregation values of the outlier points to a sum of aggregation values of all points in the target point cloud. Additionally, the processor may be configured to provide a qualitative indication of OOD robustness of the feature extraction model based on the OOD influence measure, wherein a higher OOD influence measure may be indicative of lower OOD robustness.

According to some embodiments, a system for explainable classification of a target point cloud may be provided. The system may include a non-transitory memory device, wherein modules of instruction code may be stored, and at least one processor associated with the memory device. The at least one processor may be configured to execute the modules of instruction code. Upon execution of said modules of instruction code, the at least one processor may be configured to receive a target point cloud including a plurality N of points in a multidimensional space. The processor may be further configured to apply a feature extraction model on the target point cloud to extract, for each point of the N points, a respective permutation-invariant feature vector including a plurality of local feature entries. The processor may also be configured to apply a bottleneck function on the permutation-invariant feature vectors of the N points to produce a global feature vector having a plurality F of global feature entries. Additionally, the processor may be configured to apply a classification model on the global feature vector to classify the target point cloud according to one or more classification criteria. The processor may be further configured to, for one or more points of the N points, apply an aggregation function over the local feature entries of the respective permutation-invariant feature vector, prior to the bottleneck function, to obtain a respective aggregation value. The processor may also be configured to indicate importance of the one or more points in said classification based on their respective aggregation values.

According to some embodiments, the bottleneck function may include a pooling function that aggregates the permutation-invariant feature vectors across the N points along a points dimension to produce the global feature vector.

According to some embodiments, the pooling function may be selected from a list consisting of: (i) a maximum pooling function, (ii) a mean pooling function, (iii) a weighted pooling function applied on values of corresponding local feature entries of the permutation-invariant feature vectors, (iv) a dense artificial Neural Network (NN) bottleneck layer applied on the permutation-invariant feature vectors, (v) a NN convolutional layer applied on the permutation-invariant feature vectors, and any combination thereof.

According to some embodiments, applying the aggregation function of a specific point of the N points may include at least one of: (i) summing local feature entries of that point, (ii) summing absolute values of local feature entries of that point, (iii) performing a weighted sum of local feature entries of that point, (iv) applying a predetermined function on a majority of local feature entries of that point, and any combination thereof.

According to some embodiments, the at least one processor may be further configured to apply a rotation transformation to the target point cloud to produce a rotated point cloud. The processor may be configured to, for one or more points of the N points: (a) apply the feature extraction model on the rotated point cloud to extract a respective rotated permutation-invariant feature vector having a plurality of local feature entries, (b) apply the aggregation function over the local feature entries of the respective rotated permutation-invariant feature vector, prior to the bottleneck function, to obtain a respective rotated aggregation value, and (c) compute a pointwise deviation measure based on a difference between the respective aggregation value and the respective rotated aggregation value. The processor may also be configured to provide a qualitative indication of rotation invariance of the feature extraction model and/or classification model based on the pointwise deviation measure.

According to some embodiments, the at least one processor may be further configured to identify a set of outlier points within the target point cloud, wherein the outlier points may be out-of-distribution (OOD) points not present during training of the feature extraction model. The processor may be configured to compute an OOD influence measure as a ratio of a sum of aggregation values of the outlier points to a sum of aggregation values of all points in the target point cloud. The processor may also be configured to provide a qualitative indication of OOD robustness of the feature extraction model and/or classification model based on the OOD influence measure, wherein a higher OOD influence measure may be indicative of lower OOD robustness.

According to some embodiments, the at least one processor may be further configured to identify a geometric symmetry property of the target point cloud. The processor may be configured to analyze a distribution of the aggregation values across the target point cloud to determine a symmetry influence measure. The processor may also be configured to compare the symmetry influence measure to the geometric symmetry property. Additionally, the processor may be configured to provide a qualitative indication of dataset bias in training data used to train the feature extraction model and/or classification model based on the comparison.

The foregoing general description of the illustrative embodiments and the following detailed description thereof are merely exemplary aspects of the teachings of this disclosure and are not restrictive.

### BRIEF DESCRIPTION OF FIGURES

The patent or application file contains at least one drawing executed in color. Copies of this patent or patent application publication with color drawing(s) will be provided by the Office upon request and payment of the necessary fee.

Non-limiting and non-exhaustive examples are described with reference to the following figures. The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting a computing device which may be included in a system for providing explainable point-cloud classification, according to some embodiments;

FIG. 2 is a block diagram depicting a system for explainable point-cloud classification, according to some embodiments of the invention;

FIG. 3 is a flow diagram depicting a method of generating explainable point-cloud classification, according to some embodiments of the invention;

FIG. 4 is an illustration of gradients computed on a point cloud sample using different point cloud classification networks, according to some embodiments of the invention;

FIG. 5 is a qualitative comparison between aggregation values computed according to embodiments of the invention and critical points computed using post-bottleneck methods, according to some embodiments of the invention;

FIG. 6 is a graph depicting AUC as a function of the order p of the L^{p} norm, according to some embodiments of the invention;

FIG. 7 is an illustration of rotation invariance analysis depicting a point cloud at different rotations color-coded by aggregation values, according to some embodiments of the invention;

FIG. 8 is an illustration of OOD robustness analysis depicting networks trained on a first dataset and evaluated on corrupted or real-world data, according to some embodiments of the invention;

FIGS. 9A-B depict correlation between OOD influence measure and OOD accuracy, including panel 9A depicting a scatter plot and panel 9B depicting a summary table, according to some embodiments of the invention; and

FIG. 10 is an illustration of influence on supervised and self-supervised methods, according to some embodiments of the invention.

### DETAILED DESCRIPTION

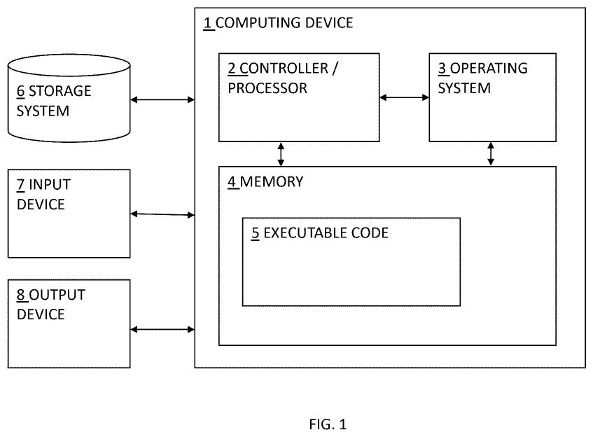

Reference is now made to FIG. 1, which is a block diagram depicting a computing device, which may be included within an embodiment of a system for explainable classification of a target point cloud, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may produce explainable classification of a target point cloud as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to a target point cloud may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8. A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

As explained herein, system 10 (also referred to as FBI system 10) may include, or may be communicatively connected to a point cloud network 110, configured to classify incoming point cloud instances 20 according to predetermined classification categories. System 10 may interface point cloud network 110 to provide explainability for such classification 150C, provide notifications to identify sub-optimal classification 150C and optionally retrain one or more elements of point cloud network 110 so as to optimize classification 150C.

According to some embodiments, system 10 may compute pointwise importance with respect to a trained point-cloud network's 110 downstream task, facilitating better understanding and debugging of the network. As explained herein, embodiments of the FBI method may use a predetermined norm (e.g., the L1 norm) of features per point before a pooling bottleneck of point-cloud network 110. system 10 may thereby achieve high-quality ranking of importance and at least three orders of magnitude speedup compared to currently available, comparable XAI methods.

The approach presented by embodiments of the invention may be highly scalable for large point clouds and complex architectures, achieving state-of-the-art results in classification explainability. It may be particularly useful for analyzing aspects of 3D learning such as rotation invariance, robustness to out-of-distribution outliers, domain shift, and dataset bias.

Embodiments of the present invention may introduce a novel approach to compute the features' norm per point before the pooling bottleneck, which is not present in existing XAI methods for point clouds. Embodiments of the method may thereby avoid gradient computations and iterative processes, providing smoother, more reliable, robust and rapid ranking of point importance.

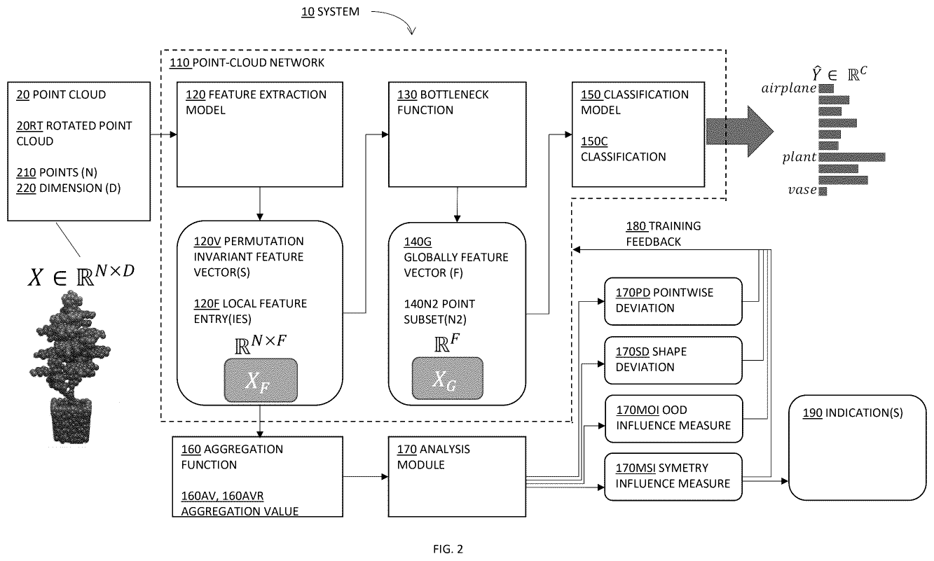

Reference is now made to FIG. 2 which depicts a system 10 for explainable point-cloud classification, according to some embodiments of the invention.

According to some embodiments of the invention, system 10 may be implemented as a software module, a hardware module, or any combination thereof. For example, system 10 may be, or may include a computing device such as element 1 of FIG. 1, and may be adapted to execute one or more modules of executable code (e.g., element 5 of FIG. 1) to provide explainable point-cloud classification, as further described herein. As shown in FIG. 2, arrows may represent flow of one or more data elements to and from system 10 and/or among modules or elements of system 10. Some arrows have been omitted in this figure for the purpose of clarity.

As shown in FIG. 2, system 10 may include, or may be associated with a point-cloud network 110. Point-cloud network 110 may be adapted to receive (e.g., via input 7 of FIG. 1) a target point cloud 20, and analyze, or classify target point cloud 20 according to predetermined criteria.

According to some embodiments, a point cloud X (20) may include N points in a multidimensional space (e.g., 3D), where each point Xᵢ∈ [symbol] ^{D} and D=3 for 3D coordinates (though the input may be of higher dimensions). A per-point feature vector X_{F}∈ [symbol] ^{R×F} may be extracted, where X_{F}(i, ·) is a vector of F real-valued features of point Xᵢ. To obtain a global feature vector in a permutation-invariant manner, a pooling function such as Max-Pooling or a combination of Max-Pooling and Mean-Pooling may be applied. The pooling may be performed with respect to the points dimension, so following the pooling bottleneck, a global feature vector X_{G}=Pooling(X_{F})∈ [symbol] ^{F} may be obtained.

Embodiments of the invention may be based on intermediate features of the network, probed from the pre-bottleneck stage of the network. There may be a strong correlation between the magnitude of the features, the importance of their semantic meaning, and consequently their contribution to the network's downstream task.

According to some embodiments, A Feature-Based Interpretability (FBI) value, also referred to as an Aggregation Value (AV, denoted 160AV) of a point Xᵢ may be defined by:

$$AV ( i ) : = {\sum }_{k = 1}^{F} \vert {X}_{F} ( i , k ) \vert$$

According to some embodiments, probing prior to bottleneck function 130 may be advantageous. The bottlenecks of graph neural networks may be highly aggressive and may reduce significant information regarding the input data. For the case of Max-Pooling, the gradient of the network prediction with respect to a data point may be examined. Let \vec{X}_{F}∈ [symbol] ^{N·F} be the column stack of the matrix X_{F}∈ [symbol] ^{N×F}. The derivative of the prediction, Ŷ∈ [symbol] ^{C}, with respect to a point Xᵢ, using the chain rule, may be expressed as:

$$\frac{\partial \hat{Y}}{\partial {X}_{i}} = {\overbrace{\frac{\partial \hat{Y}}{\partial {X}_{G}}}}^{C \times F} \cdot {\overbrace{{\underbrace{\frac{\partial {X}_{G}}{\partial {\vec{X}}_{F}}}}_{{F \times ( N \cdot F )}_{{︸}_{C \times D}}}}}^{Post - Bottleneck} \cdot {\overbrace{{\underbrace{\frac{\partial {\vec{X}}_{F}}{\partial {X}_{i}}}}_{( N \cdot F ) \times D}}}^{Pre - Bottleneck}$$

Assuming Max-Pooling, X_{G}=max_{N}(X_{F}). The derivative of the max function may be 1 at the maximal value and zero for all other entries. Thus, the explicit term of

$$\frac{\partial {X}_{G} ( k )}{\partial {X}_{F}}$$

may be a matrix unit [symbol] ⱼ_{ₖ}_{,k} that has a single nonzero entry with value 1 at (jₖ, k), where jₖ ∈{1, . . . ,N} is the index of the point with maximal value corresponding to feature k (that is, jₖ:X_{F}(jₖ, k)>X_{F}(j,k),∀j≠jₖ).

According to some embodiments, for certain network architectures (e.g., PointNet) where

$$\frac{\partial {x}_{F} ( j , \cdot )}{\partial {X}_{i}} = 0 , ∀ i , j ∈ \{ 1 , … , N \} , j \neq i ,$$

and where N>F, there may exist at least N−F points such that

$$\frac{\partial \hat{Y}}{\partial {X}_{i}} = 0.$$

This may occur because

$$\frac{\partial {X}_{G}}{\partial {X}_{i}} = 0$$

for any i∉{j₁,j₂, . . . ,j_{F}}. Since the set {j₁,j₂, . . . ,j_{F}} contains at most F elements and N>F, there may exist at least N−F elements for which the gradient is zero. Accordingly, gradient-based methods may fail to provide meaningful importance measures for a majority of points in the point cloud, whereas embodiments of the pre-bottleneck aggregation approach may provide non-zero aggregation values 160AV for all points 210.

According to some embodiments, system 10 may include an aggregation module 160, and an analysis module 170. Aggregation module 160 may be adapted to generate, for one or more points 210 of the N points, a respective aggregation value 160AV representing importance or prominence of the respective point in classification 150C. Analysis module 170 may receive aggregation values 160AV from aggregation function 160 and perform various analyses, such as rotation invariance analysis, out-of-distribution (OOD) robustness assessment, and dataset bias detection, as further described herein.

As shown in FIG. 2, point-cloud network 110 may include a feature extraction model 120 (e.g., a Neural Network (NN)), adapted to receive a target point cloud 20 of interest (e.g., via input 7 of FIG. 1). Target point cloud 20 may originate, for example, from a device or sensor such as a LIDAR, and may include a plurality N of points 210 in a multidimensional (e.g., 3D) space having a dimension 220 (e.g., 3).

System 10 may employ feature extraction model 120 on target point cloud 20 (on points 210) to extract, for one or more (e.g., each) point 210 of N, a respective permutation-invariant feature vector 120V. Permutation-invariant feature vector 120V may include a plurality of local feature entries 120F, each representing a locally-significant feature value.

According to some embodiments, point-cloud network 110 may further include a bottleneck module, or bottleneck function 130. such as a maximum-pooling or average pooling function. As known in the art, point cloud networks are constrained to maintain permutation invariance. Therefore, currently available point cloud network implementations typically apply such bottleneck stages to a majority (e.g., all) of points 210. This may drastically diminish the size of features in point-cloud network 110 (e.g., by more than one order of magnitude). This drastic reduction may also hamper explainability, as it may be difficult to back-track influence of specific points 210 on classification 150C.

Bottleneck function 130 may be, or may include for example a pooling function that aggregates the permutation-invariant feature vectors 120V across the N points along a points dimension to produce a global feature vector 140G.

In another example, bottleneck function 130 may include a maximum pooling function that selects the maximum value of each feature across the N points as global feature vector 140G.

In another example, bottleneck function 130 may include a mean or average pooling function that computes the average value of each feature across the N points, or a weighted pooling function applied on values of corresponding local feature entries 120F of the permutation-invariant feature vectors 120V to compute weighted combinations of feature values as global feature vector 140G.

In another example, bottleneck function 130 may be implemented as a dense artificial Neural Network (NN) bottleneck layer applied on the permutation-invariant feature vectors 120V, configured to learn compressed representations through fully-connected layers, or a NN convolutional layer applied on the permutation-invariant feature vectors 120V to extract hierarchical features through learned filters as global feature vector 140G. Additional implementations or combinations of such bottleneck functions 130 may also be possible.

Global feature vector 140G may have globally-significant feature values, in a sense that they may correspond to extremum, or unique values of permutation-invariant features in a large portion (e.g., most, or all of) target point cloud 20. For example, global feature vector 140G may be characterized as having maximal values of one or more permutation-invariant features, across target point cloud 20. Additionally, or alternatively, bottleneck function 130 may correspond to, or indicate a subset 140N2 of points 210 that correspond to the global feature vector 140G entries.

It may be appreciated that the number of global feature 140G entries (also denoted ‘F’) in global feature vector 140G may be in the same order of magnitude as the number of permutation-invariant features in feature extraction model 120. According to some embodiments, the total number of local feature entries 120F across the N points (e.g., N×F) may exceed the number of global feature entries (e.g., F) by at least one order of magnitude.

According to some embodiments, point-cloud network 110 may apply classification model 150 on global feature vector 140G, to classify 150C target point cloud 20 according to one or more classification criteria. In the example of FIG. 2, classification model 150 may produce classification 150C that associates point cloud 20 with one or more types of objects, such as an airplane, a plant, a vase, and the like.

According to some embodiments, system 10 may apply aggregation function 160 on the local feature entries 120F of one or more points 210 of the N points, prior to the bottleneck function 130. Aggregation function 160 may thereby obtain a pointwise-respective aggregation value 160AV.

For example, aggregation function 160 of a specific point 210 of the N points may include summing local feature entries 120F of that point 210. In another example, aggregation function 160 may include summing absolute values of local feature entries 120F of that point, or performing a weighted sum of local feature entries 120F of that point.

In yet another example, aggregation module 160 may be configured to apply a predetermined function on a portion (e.g., a majority) of local feature entries 120F of points 210 of the plurality of N points. Such predetermined functions may include, for example, a median function that computes the median value of the local feature entries, a percentile function that computes a specified percentile value, a trimmed mean function that computes an average after excluding extreme values, a top-k function that selects and aggregates the k highest local feature entries, a threshold function that aggregates only local feature entries exceeding a predetermined threshold value, a variance function that computes the variance or standard deviation of the local feature entries, and any combination thereof. Additional implementations or combinations of such aggregation functions 160 may also be possible.

As explained herein, aggregation value 160AV may be highly indicative of the importance of respective points 210 of N in classification 150C. For example, a first point 210 that corresponds to a high level of aggregation value 160AV may be more prominent or important, for the purpose of classification 150C, than a second point 210 having a lower aggregation value 160AV.

According to some embodiments, system 10 may provide indication 190, reflecting importance of the one or more points 210 in classification 150C based on their respective aggregation values 160AV. System 10 may provide such indications 190 of importance in various ways:

For example, indications 190 may include ranking and presenting the one or more points 210 according to their respective aggregation values 160AV. Additionally, or alternatively, indications 190 may include generating an influence map (e.g., a color-coded map), associating each of the one or more points 210 with a respective aggregation value 160AV. In another example, indications 190 may include identifying a subset of points 210 having aggregation values 160AV above a predetermined threshold as high-importance points. In yet another example, indications 190 may include providing a visualization of target point cloud 20 (e.g., via output device 8 of FIG. 1) wherein the one or more points 210 are visually distinguished based on their respective aggregation values 160AV. Additional implementations and combinations of such indications 190 may may also be possible.

Additionally, or alternatively, system 10 may provide online feedback during inference of classification model 150 based on the respective aggregation values 160AV. For example, as may be appreciated, point clouds may be data structures representing 3D environments, which may serve as sensory input in robotics and autonomous driving applications. The low computational complexity of embodiments of the invention may facilitate online explainability feedback at inference, indicating which points 210 are most influential in classification 150C. Such explainability feedback may help operators or downstream systems understand why a particular classification was made. In safety-critical applications, such as autonomous driving, understanding which points influenced a classification decision may help identify potential misclassifications or increase confidence in correct classifications. The low computational complexity may enable this explainability feedback to be provided in real-time without slowing down inference. Embodiments of the method may therefore be well-suited for time-demanding processes, particularly when applying explainable methods during inference.

According to some embodiments, system 10 may be configured to analyze rotation invariance of feature extraction model 120 and/or classification model 150. As shown in FIG. 2, system 10 may receive an instance of a target point cloud 20 of interest. System 10 may further receive a rotated point cloud 20RT (e.g., via input 7 of FIG. 1), or generate rotated point cloud 20RT by applying a rotation transformation to target point cloud 20.

System 10 may apply feature extraction model 120 on rotated point cloud 20RT to extract, for one or more points of the N points, respective rotated permutation-invariant feature vectors 120V having a plurality of local feature entries 120F. System 10 may then apply aggregation function 160 over the local feature entries 120F of the rotated permutation-invariant feature vectors, prior to bottleneck function 130, to obtain a respective rotated aggregation value 160AVR. According to some embodiments, analysis module 170 may subsequently compute, for one or more points 210 of the N points, a pointwise deviation 170PD value, based on a difference between the respective aggregation value 160AV and the respective rotated aggregation value 160AVR of rotated point cloud 20RT.

Pointwise deviation 170PD may be represented as a ratio of the absolute difference between the rotated aggregation value 160AVR and the aggregation value 160AV to the aggregation value 160AV. For example, pointwise deviation 170PD may be computed as

$$δ = \frac{\vert {AV}^{rotated} - {AV}^{clean} \vert}{A {V}^{clean}} ,$$

where AV^{rotated} denotes the rotated aggregation value 160AVR of rotated point cloud 20RT, and AV^{clean} denotes aggregation value 160AV of the original, non-rotated target point cloud 20.

According to some embodiments, system 10 may provide (e.g., as indications 190) a qualitative indication 190 of rotation invariance of feature extraction model 120 and/or classification model 150 based on pointwise deviation 170PD. A lower pointwise deviation 170PD may indicate that feature extraction model 120 and/or classification model 150 maintains more consistent influence for each point during rotations, and is thus better equipped to handle rotational variations. A higher pointwise deviation 170PD may indicate that feature extraction model 120 and/or classification model 150 is more affected by rotations, with influence that may be distributed differently over the shape for each rotation.

Additionally, or alternatively, analysis module 170 may calculate a shape deviation 170SD based on pointwise deviation measures 170PD of the one or more points of target point cloud 20. Shape deviation 170SD may, for example, be computed by averaging pointwise deviation measures 170PD across all points of target point cloud 20, across multiple point clouds in a dataset, and/or across multiple rotation severities. Shape deviation 170SD may provide an overall measure of how rotation affects the distribution of influence of points 210 across target point cloud 20.

According to some embodiments, based on shape deviation 170SD, system 10 may provide training feedback 180 for retraining classification model 150 and/or feature extraction model 120, so as to improve rotation invariance. Training feedback 180 may, for example, include information indicating which points or regions of target point cloud 20 exhibit high pointwise deviation 170PD, enabling targeted improvements to the models. A network that tends to maintain consistent influence for each point during rotations, as indicated by lower shape deviation 170SD, may be better equipped to handle rotational variations in downstream classification tasks.

According to some embodiments, system 10 may be configured to analyze out-of-distribution (OOD) robustness of feature extraction model 120 and/or classification model 150. As shown in FIG. 2, analysis module 170 may identify a set of outlier points 210 within target point cloud 20, wherein the outlier points are OOD points not present during training of feature extraction model 120.

According to some embodiments, analysis module 170 may identify outlier points using one or more identification methods. For example, analysis module 170 may apply statistical methods to detect points 210 having feature values that deviate significantly from a distribution of feature values observed during training. In another example, analysis module 170 may apply density-based detection methods to identify points located in low-density regions of a feature space learned during training. In yet another example, analysis module 170 may compute a distance from training distribution for each point, identifying as outliers those points having distances exceeding a predetermined threshold. Additional identification methods may include anomaly detection algorithms, clustering-based methods that identify points not belonging to any learned cluster, or neural network-based outlier detectors trained to distinguish in-distribution points from OOD points. Combinations of such identification methods may also be possible.

According to some embodiments, analysis module 170 may compute an OOD influence measure 170MOI based on aggregation values 160AV of the identified outlier points. OOD influence measure 170MOI may, for example, be computed as a ratio of a sum of aggregation values 160AV of the outlier points to a sum of aggregation values 160AV of all points in target point cloud 20. For example, OOD influence measure 170MOI may be represented as

$$R = \frac{{\sum }_{j ∈ O} {AV}_{j}}{{\sum }_{k ∈ S} {AV}_{k}} ,$$

where O denotes the set of outlier points, S denotes the set of all points in target point cloud 20, and AV denotes the respective aggregation values 160AV.

According to some embodiments, system 10 may provide, via indications 190, a qualitative indication of OOD robustness of feature extraction model 120 and/or classification model 150 based on OOD influence measure 170MOI. A higher OOD influence measure 170MOI may be indicative of lower OOD robustness, as it may suggest that feature extraction model 120 and/or classification model 150 allocate disproportionate influence to outlier points 210 not encountered during training. Conversely, a lower OOD influence measure 170MOI may indicate that feature extraction model 120 and/or classification model 150 maintains focus on semantically relevant regions of target point cloud 20, even in the presence of outliers.

According to some embodiments, analysis module 170 may compare OOD influence measure 170MOI to a predetermined threshold. Based on the comparison, system 10 may provide training feedback 180 for retraining feature extraction model 120 and/or classification model 150 to reduce influence allocated to outlier points, so as to improve OOD robustness. Training feedback 180 may include information indicating which outlier points or regions of target point cloud 20 exhibit high aggregation values 160AV, enabling targeted improvements to reduce susceptibility to OOD points.

According to some embodiments, system 10 may be configured to detect dataset bias in training data used to train feature extraction model 120 and/or classification model 150. As shown in FIG. 2, analysis module 170 may identify a geometric symmetry property of target point cloud 20. Such geometric symmetry property may include, for example, axial symmetry (e.g., z-axis symmetry), rotational symmetry, reflective symmetry, or any combination thereof.

According to some embodiments, analysis module 170 may analyze a distribution of aggregation values 160AV across target point cloud 20 to determine a symmetry influence measure 170MSI. Symmetry influence measure 170MSI may quantify the degree to which the distribution of aggregation values 160AV corresponds to the identified geometric symmetry property of target point cloud 20. For example, for an object having z-axis symmetry, symmetry influence measure 170MSI may indicate whether aggregation values 160AV are distributed symmetrically about the z-axis, or whether they exhibit asymmetric patterns such as disproportionate emphasis on a frontal region of the object.

According to some embodiments, analysis module 170 may compare symmetry influence measure 170MSI to the geometric symmetry property of target point cloud 20. A mismatch between symmetry influence measure 170MSI and the geometric symmetry property may indicate dataset bias in the training data. For example, if target point cloud 20 represents a symmetric object (e.g., a bottle or cone having z-axis symmetry) but the distribution of aggregation values 160AV exhibits asymmetric influence emphasizing a frontal aspect of the object, this may suggest that the training data contained a disproportionate number of instances with distinguishing features positioned at the frontal region, causing feature extraction model 120 and/or classification model 150 to focus disproportionately on that region.

According to some embodiments, system 10 may provide, via indications 190, a qualitative indication of dataset bias in training data used to train feature extraction model 120 and/or classification model 150 based on the comparison between symmetry influence measure 170MSI and the geometric symmetry property. Such qualitative indication 190 may alert operators or downstream systems to potential spurious cues or shortcuts learned by feature extraction model 120 and/or classification model 150 due to biases in the training dataset.

According to some embodiments, based on the qualitative indication 190 of dataset bias (e.g., based on the comparison between symmetry influence measure 170MSI and the geometric symmetry property), system 10 may provide training feedback 180 for retraining feature extraction model 120 and/or classification model 150.

Training feedback 180 may include recommendations for retraining using a self-supervised learning approach, wherein the absence of labels may reduce susceptibility to dataset bias. Additionally, or alternatively, training feedback 180 may include recommendations for retraining using augmented training data, which may alleviate asymmetry in the influence distribution. Combinations of such retraining approaches may also be possible, so as to reduce susceptibility to dataset bias.

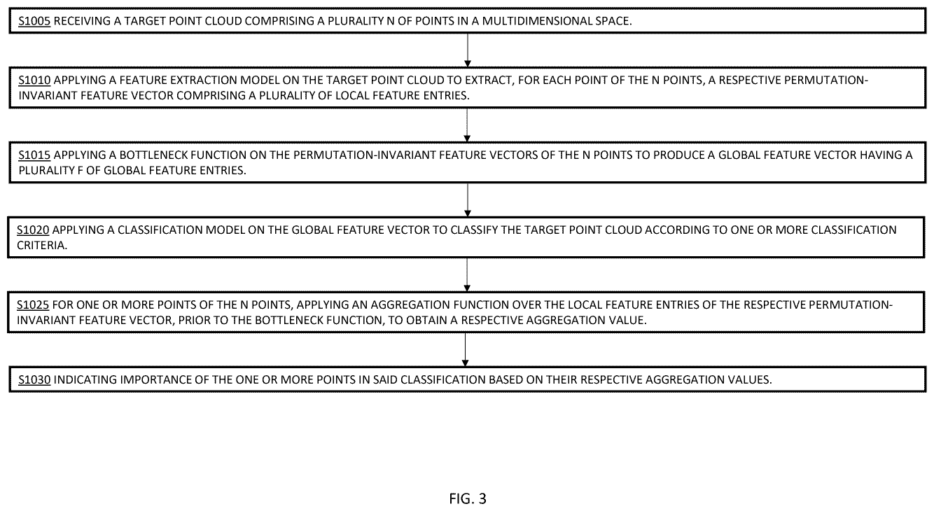

Reference is now made to FIG. 3, which depicts a flowchart illustrating a method of generating explainable classification of a target point cloud, by at least one processor, according to some embodiments of the invention.

In step S1005, system 10 may receive a target point cloud 20 (FIG. 2) including a plurality N of points 210 in a multidimensional space having dimension 220. Target point cloud 20 may be received, for example, via input 7 of computing device 1 (FIG. 1), and may originate from a device or sensor such as a LIDAR.

In step S1010, system 10 may apply feature extraction model 120 (FIG. 2) on target point cloud 20 to extract, for each point of the N points 210, a respective permutation-invariant feature vector 120V including a plurality of local feature entries 120F. Feature extraction model 120 may be implemented, for example, as a Neural Network (NN) executed by processor 2 of computing device 1 (FIG. 1).

In step S1015, system 10 may apply bottleneck function 130 (FIG. 2) on the permutation-invariant feature vectors 120V of the N points 210 to produce a global feature vector 140G having a plurality F of global feature entries. Bottleneck function 130 may include, for example, a pooling function such as a maximum pooling function or a mean pooling function that aggregates the permutation-invariant feature vectors 120V across the N points along a points dimension.

In step S1020, system 10 may apply classification model 150 (FIG. 2) on global feature vector 140G to classify target point cloud 20 according to one or more classification criteria. Classification model 150 may produce classification 150C that associates target point cloud 20 with one or more types of objects, such as an airplane, a plant, a vase, and the like. Classification model 150 may be executed by processor 2 of computing device 1 (FIG. 1).

In step S1025, for one or more points 210 of the N points, system 10 may apply aggregation function 160 (FIG. 2) over the local feature entries 120F of the respective permutation-invariant feature vector 120V, prior to bottleneck function 130, to obtain a respective aggregation value 160AV. Aggregation function 160 may include, for example, summing local feature entries 120F, summing absolute values of local feature entries 120F, or performing a weighted sum of local feature entries 120F.

In step S1030, system 10 may indicate importance of the one or more points 210 in classification 150C based on their respective aggregation values 160AV. Such indications 190 (FIG. 2) may be provided, for example, via output device 8 of computing device 1 (FIG. 1), and may include ranking the one or more points 210 according to their respective aggregation values 160AV, generating an influence map associating each of the one or more points 210 with a respective aggregation value 160AV, or providing a visualization of target point cloud 20 wherein the one or more points 210 are visually distinguished based on their respective aggregation values 160AV.

Embodiments of the invention may implement a practical application in the technological field of machine-learning classification and explainability. As explained herein, embodiments of the invention may achieve at least three orders of magnitude speedup compared to currently available XAI methods, manifesting significant improvement in Artificial Intelligence (AI) technology.

Additionally, timing of embodiments of the method may be approximately constant regardless of network architecture, since no derivation across layers may be performed. Embodiments of the method may thereby be scalable for large point clouds or complex architectures, achieving state-of-the-art results in classification explainability.

Furthermore, embodiments of the method may provide smoother, more robust influence measures that overcome the issue of zero influential points commonly encountered in gradient-based methods.

Embodiments of the invention may provide practical applications with real-world effects. For example, point clouds may include data structures in 3D processing that serve as input in robotics and autonomous driving applications. Embodiments of the method may facilitate better understanding of network properties, which may be beneficial for safety-critical applications. Additionally, embodiments of the method may provide debugging and visualization capabilities, as well as online feedback during inference to reduce uncertainty and increase robustness. Embodiments of the method may thereby be instrumental in improving navigation, classification, and AI-related tasks involving neural networks operating on point clouds.

Embodiments of the invention may provide improvements over currently available systems and methods. As known in the art, current XAI methods for point clouds may be slow due to gradient computations or time-consuming iterative processes. Additionally, the quality of explanations from current methods may be inadequate and non-smooth, especially for gradient-based methods. Embodiments of the invention may avoid gradient computations and iterative processes by computing aggregation values from local feature entries prior to the bottleneck function. This pre-bottleneck approach may provide smoother, more reliable ranking of point importance compared to post-bottleneck measures.

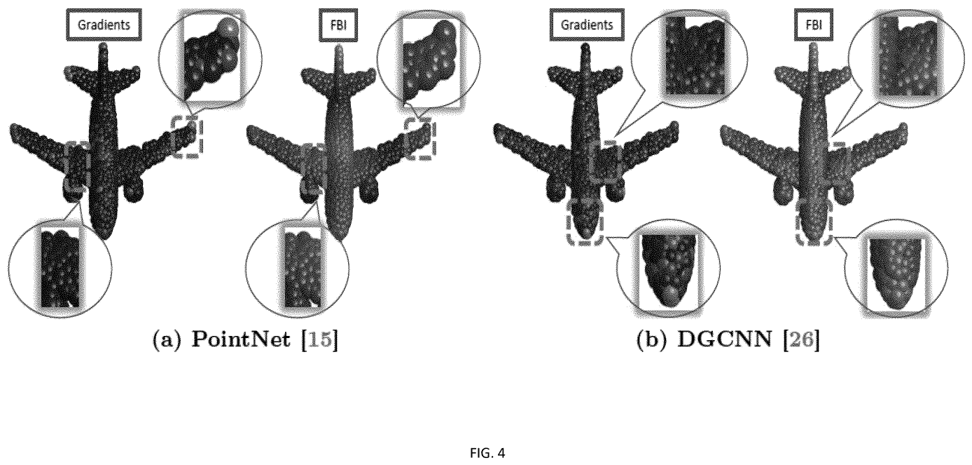

Reference is made to FIG. 4 which visualizes gradients computed on an airplane sample using different point cloud classification networks.

As shown in FIG. 4, gradients computed using certain network architectures (e.g., PointNet) may be zero outside the critical set (e.g., at a wing's base region), and may exhibit non-smooth characteristics (e.g., at a wing's edge region). This trend may be similarly observed in other network architectures (e.g., DGCNN). In contrast, aggregation values 160AV computed according to embodiments of the invention (denoted FBI) may result in a smoother influence map, indicating potential influence even for points 210 having zero gradients.

As shown in FIG. 4, there may exist points for which the gradients are zero when applied on certain network architectures. Points in less discriminative regions (e.g., wing base, outside the critical set) may have relatively low gradients. In contrast, aggregation values 160AV computed according to embodiments of the invention (marked FBI) may provide non-zero importance measures for all points 210, including those in less discriminative regions, thereby enabling a more complete ranking of point importance across target point cloud 20.

According to some embodiments, critical points (CP) may be a method commonly employed for probing after pooling.

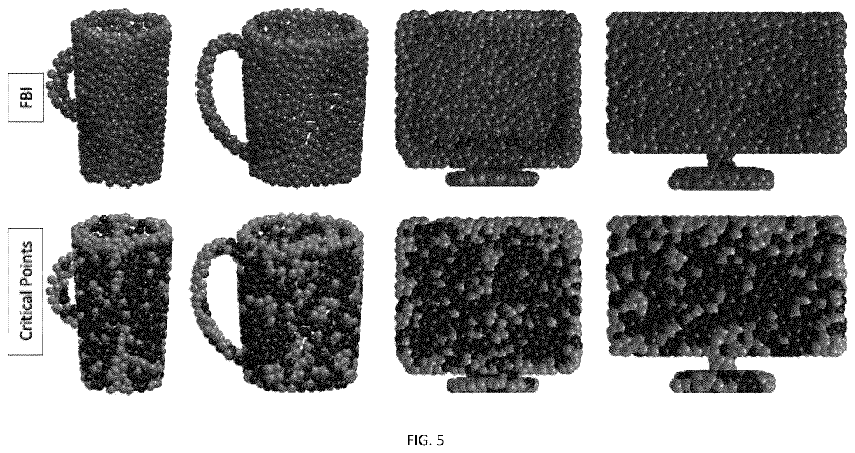

Reference is also made to FIG. 5 which is a qualitative comparison between aggregation values 160AV computed according to embodiments of the invention and critical points computed using post-bottleneck methods.

As shown in FIG. 5, critical points may provide a binary indication (active or inactive) based on whether a point remains active after the last Max-Pooling layer, whereas aggregation values 160AV may provide a continuous, smooth ranking of point importance across target point cloud 20. The comparison may illustrate that aggregation values 160AV computed prior to bottleneck function 130 may achieve smoother influence distribution and may rank points by semantic meaning, regardless of sampling resolution. In the example of FIG. 5, aggregation values 160AV computed according to embodiments of the invention may provide rankings based on semantic meaning across an entire shape of target point cloud 20. For example, elements such as a cup handle or a top portion of a monitor may exhibit high aggregation values 160AV, while other parts may receive smooth ranking. In contrast, critical points computed using post-bottleneck methods may predominantly highlight prominent regions, but in other areas, the selection of points may appear nearly random.

Critical points may be defined as the points that remain active after the last Max-Pooling layer. That is:

$$C P ( i ) : = \{ \begin{matrix}1 , & if ∃ k s . t . {X}_{F} ( i , k ) > {X}_{F} ( j , k ) , ∀ j \neq i \\ 0 , & otherwise\end{matrix}$$

The critical set may be defined by:

$${S}_{C} : = \{ i : CP ( i ) = 1 \}$$

According to some embodiments, the smoothness of the importance measure induced by critical points may be analyzed. Assuming the K-nearest-neighbors (KNN) graph of X is a connected graph, and letting h be a positive constant such that max|Xᵢ−Xⱼ|≤h, ∀i∈{1, . . . ,N}, ∀Vⱼ∈KNN(Xᵢ), and assuming

$$\frac{\partial {X}_{F} ( j , \cdot )}{\partial {X}_{i}} = 0$$

(e.g., PointNet), and N>F, then the influence induced by critical points may be K-Lipschitz with

$$K \geq \frac{1}{h} .$$

According to some embodiments, there may exist at least N−F points outside the critical set, and since F>0, there may exist at least a single point in the critical set. Therefore, for a connected graph, there may exist points i, j such that CP(Xi)=0 and CP(Xj)=1, where Xj∈KNN(Xi). The Lipschitz condition for CP may be expressed as:

$$1 = \vert CP ( {X}_{i} ) - CP ( {X}_{j} ) \vert \leq K \vert {X}_{i} - {X}_{j} \vert \leq Kh , and therefore K \geq \frac{1}{h} .$$

According to some embodiments, critical points and gradients may serve as strategies for gathering information from the post-bottleneck phase. The analysis above may demonstrate two properties: (1) for certain network architectures (e.g., PointNet), there may be at least N−F points with zero gradients (those outside the critical set), and for N>>F this may represent most of the points; and (2) the smoothness of the importance measure induced by critical points may be inversely proportional to the sampling resolution, such that critical points may become less smooth as the point cloud is sampled at a finer resolution.

According to some embodiments, the attributes of smoothness and uniqueness may be desirable for an effective influence measure. In a thought experiment, consider extracting the most influential input, perhaps a single point from the tip of a cone. It may become evident that the shape is preserved, and points in close proximity to the filtered one may be expected to exhibit higher influence than those farther away. By iteratively applying this process, spatially close points may be anticipated to exert approximately similar influence, resulting in a smooth influence map. Moreover, after filtering influential points, some initially non-influential ones may gain significance, while others may remain non-influential. Thus, influence may be meaningful, with semantic ordered ranking, even for zero-gradient points.

According to some embodiments, by probing features in the pre-bottleneck stage, embodiments of the method may assess a point's potential to contribute to classification rather than its actual contribution, given a certain point sampling. Embodiments of the method may thereby rank points, even those with zero actual contribution, resulting in a smoother influence. Furthermore, embodiments of the method may enable ranking points by semantic meaning, regardless of the sampling resolution (see FIG. 5). As shown in FIG. 4, gradients in certain network architectures may exhibit non-smooth characteristics and very low influence for parts of the shape. Aggregation values 160AV computed according to embodiments of the invention may remain smooth and may rank even less influential parts. This approach may remain effective for architectures that incorporate learning using neighbors in the featurizing step and employ Mean-Pooling along with Max-Pooling.

According to some embodiments, performance of embodiments of the method may be evaluated using a perturbation test. In such a test, points 210 may be systematically removed from target point cloud 20 (e.g., ranging from 10% to 90%), starting with the most influential ones as determined by their respective aggregation values 160AV. Accuracy may be averaged over a plurality of instances (e.g., 2468 instances in a ModelNet40 dataset), and overall test performance may be summarized using an area-under-the-curve (AUC) metric. Lower AUC values may indicate better performance, as they may suggest that the most influential points were correctly identified and removed first, thereby degrading classification accuracy more rapidly.

According to some embodiments, comparisons may demonstrate that embodiments of the method outperform other methods in most network architectures. For example, Table 1 below illustrates perturbation test results (AUC) on a ModelNet40 dataset for various XAI methods across different network architectures:

TABLE 1

| Method | DGCNN | RPC | PointNet | GDANet |
|---|---|---|---|---|
| Random Sampling | 55.60 | 66.12 | 68.65 | 59.43 |
| Lime (C = 128) | 34.80 | 47.22 | 50.68 | 43.52 |
| Lime (C = 1024) | 52.97 | 62.22 | 63.67 | 56.02 |
| Gradients | 50.64 | 59.71 | 61.95 | 54.43 |
| IntegratedGradients | 41.38 | 56.63 | 59.51 | 48.65 |
| Critical Points | 51.66 | 61.93 | 64.08 | 57.85 |
| Aggregation Values | 41.05 | 43.57 | 39.20 | 40.00 |
| (Embodiments) | | | | |

As shown in Table 1, embodiments of the method using aggregation values 160AV may outperform other baseline methods on 3 out of 4 examined network architectures, with the advantage of being several orders of magnitude faster than perturbation-based methods (e.g., Lime) which may be the only candidates with competitive results. The observed suboptimal performance of gradients and critical points may be attributed to uniformly zero gradients, as when the entire critical set is filtered, non-critical points may be randomly perturbed.

According to some embodiments, timing performance of embodiments of the method may be evaluated across different network architectures. Table 2 below illustrates timing results (in milliseconds) for various XAI methods:

TABLE 2

| Method | PointNet | GDANet | DGCNN | RPC |
|---|---|---|---|---|
| Lime (C = 128) | 50,000 | 50,000 | 50,000 | 50,000 |
| Lime (C = 1024) | 500 | 750 | 600 | 560 |
| Gradients | 6 | 15 | 8 | 15 |
| IntegratedGradients | 40 | 80 | 50 | 65 |
| Critical Points | 0.008 | 0.008 | 0.008 | 0.008 |
| Aggregation Values | 0.003 | 0.003 | 0.003 | 0.003 |
| (Embodiments of the invention) | | | | |

As shown in Table 2, embodiments of the method may obtain at least three orders of magnitude speedup compared to currently available XAI methods. Critical points may also be fast but may be less accurate (as shown in Table 1). Timing of embodiments of the method may be approximately constant, regardless of the network's architecture, since no derivation across the layers may be performed. Embodiments of the method may thereby be scalable in terms of network parameters or size of point cloud.

According to some embodiments, computing aggregation values 160AV may involve straightforward calculations on features, eliminating the need for time-consuming derivations across the entire network (as may be required for Gradients and Integrated Gradients methods), or any iterative processes (as may be involved in Lime methods). Consequently, embodiments of the method may be well-suited for time-demanding processes, particularly when considering the application of explainable methods during inference. Given the purely computational nature of embodiments of the method, scalability may be achieved, making embodiments of the method particularly advantageous for larger networks.

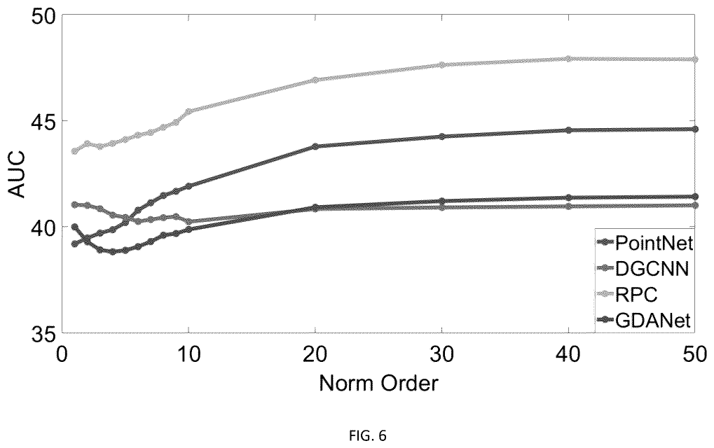

Reference is now made to FIG. 6 which is a graph depicting Area AUC as a function of the order p of the L^{p} norm, according to some embodiments of the invention. The order p measure may be defined as FBIₚ(i):=∥X_{F}(i,·)∥_{L}_{^{p}}.

According to some embodiments, embodiments of the method may be simple and parameter-free. For completeness, the impact of different L^{p} norms on computing aggregation values 160AV may be investigated. As shown in FIG. 6, AUC may be assessed on a grid of norm orders p for various network architectures (e.g., PointNet, RPC, GDANet, and DGCNN).

According to some embodiments, optimal results for certain network architectures (e.g., RPC and PointNet) may be achieved with the L1 norm, while other network architectures (e.g., DGCNN and GDANet) may show improved performance with a higher norm order. To maintain simplicity, embodiments of the method may adopt the L1 norm as the aggregation function 160. However, other norm orders may be employed depending on the specific network architecture or application requirements.

According to some embodiments, beyond its conventional role in debugging, explainable AI may be a powerful tool for illuminating fundamental aspects of 3D analysis. Aggregation values 160AV computed according to embodiments of the invention may be employed to gain a comprehensive understanding of key facets of point cloud classification. For example, influence maps of rotation-invariant networks may be compared against their classic counterparts. Additionally, insights into the decision-making processes of the network when confronted with out-of-distribution scenarios may be provided, as well as distinctions between self-supervised and supervised methods.

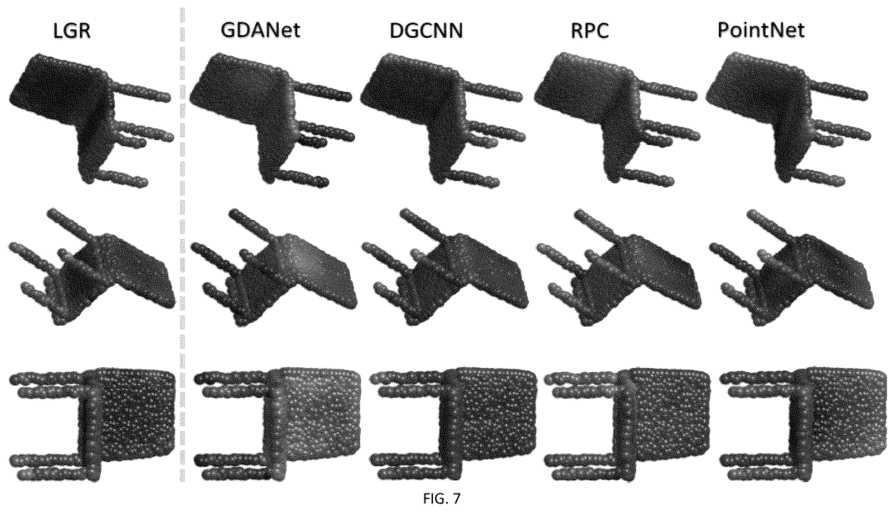

Reference is now made to FIG. 7 which is an illustration of rotation invariance analysis, according to some embodiments of the invention. FIG. 7 depicts a chair at different rotations, color-coded by aggregation values 160AV, highlighting the influence distribution across various orientations.

According to some embodiments, a relevant aspect of 3D classification may involve accounting for object rotations to ensure that a rotated object is consistently classified as the same object. This characteristic may spur the development of rotation-invariant classification networks. One example may be a Local-Global-Representation (LGR) network, designed to integrate local geometry and global topology in a rotation-invariant manner. As shown in FIG. 7, the influence distributed on the rotated shapes may appear more consistent across various rotations in rotation-invariant networks (e.g., LGR), highlighting their effectiveness as rotation-invariant networks. In contrast, traditional networks may be notably affected by the rotation of the shape, with influence distributed differently over the shape for each rotation.

According to some embodiments, quantitative analysis may be conducted to assess the impact of rotations on various networks. For a rotation-invariant network, consistent influence for each point may be anticipated irrespective of the rotation of the shape. To quantify the influence deviation of rotated shapes, a per-point deviation measure may be computed, represented as:

$$δ = \frac{( {AV}^{rotated} - {AV}^{clean} )}{{AV}^{clean}}$$

where AV^{rotated} ∈ [symbol] ^{N} may be computed on the rotated shape, and AV^{clean} ∈ [symbol] ^{N} may be the aggregation value of the unrotated shape. This deviation measure may be averaged across all points of the shape, all shapes in the dataset, and across all severities of rotations. The deviation measure may effectively gauge the extent of feature magnitude deviation induced by rotation compared to the clean feature magnitude.

Table 3 below presents a summary of the correlation between 8 and accuracy under rotations.

TABLE 3

| Model | δ [%] | Accuracy [%] |
|---|---|---|
| LGR | 1% | 91.1% |
| GDANet | 52% | 78.8% |
| DGCNN | 174% | 78.5% |
| RPC | 215% | 76.8% |
| PointNet | 2873% | 59.1% |

As shown in Table 3, a network that tends to maintain consistent influence for each point during rotations may be better equipped to handle rotational variations. Lower δ values may indicate consistent feature influence during rotations, which may be well correlated to higher accuracy. It may be noted that even rotation-invariant networks (e.g., LGR) may not perfectly preserve influence under rotations.

According to some embodiments, aggregation values 160AV computed according to embodiments of the invention may be employed to analyze robustness to out-of-distribution (OOD) data, such as outliers. In image classification, it has been argued that feature magnitudes of unknown samples may be lower than those of known ones. In the context of point clouds, the same characteristic may be investigated, and surprisingly, the opposite trend may be observed. Outlier points may exhibit higher feature magnitudes than benign points.

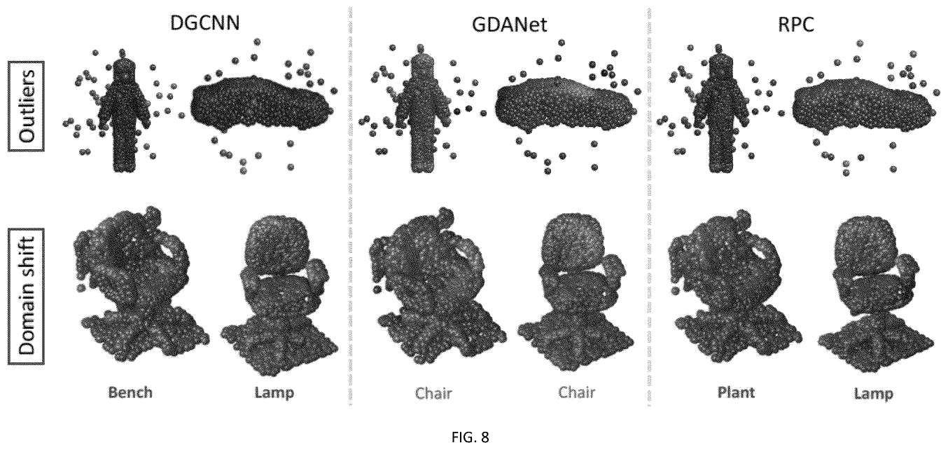

Reference is now made to FIG. 8 which is an illustration of OOD robustness analysis, according to some embodiments of the invention. FIG. 8 depicts networks trained on a first dataset (e.g., ModelNet40) and evaluated either on corrupted data (e.g., ModelNet-C) or real-world data (e.g., ScanObjectNN), color-coded by aggregation values 160AV.

According to some embodiments, this observation may hold across multiple architectures trained on a given dataset. To visualize this phenomenon, aggregation values 160AV may be employed to examine the influence maps of these networks on corrupted samples, focusing on Add-Global corruption. The networks may be trained on uncorrupted samples, without outliers, and evaluated on corrupted ones. Therefore, outliers introduced in the corrupted dataset may be categorized as OOD, since they were not introduced during training. As shown in FIG. 8, in 3D classification, outliers may tend to be highly influential. Consequently, the magnitude of OOD features may be higher than that of in-distribution features. Architectures that are influenced by semantic regions, even in the presence of outliers or background, may be more OOD robust.

According to some embodiments, to quantitatively validate this assertion, the attention gained by outliers relative to the total influence distributed over the entire shape may be computed. Let i denote a sample index, Oᵢ be the outlier points set, and Sᵢ be the set of all points in the shape (i.e., Oᵢ⊂Sᵢ). OOD influence measure 170OOD (also denoted Rᵢ) may be defined as the fractional influence that outliers gained:

$${R}_{i} = \frac{{\sum }_{j ∈ {O}_{i}} AV ( j )}{{\sum }_{j ∈ {S}_{i}} AV ( j )}$$

According to some embodiments, OOD influence measure 170OOD may be averaged over an entire corrupted dataset across all degrees of severity. As the network tends to allocate more influence to the outliers, the overall performance may drop. A linear dependency may be observed between the fraction of influence (R) allocated to outliers and OOD robustness. Networks allocating less influence to outlier points may exhibit superior robustness to both out-of-distribution outliers and domain shift scenarios.

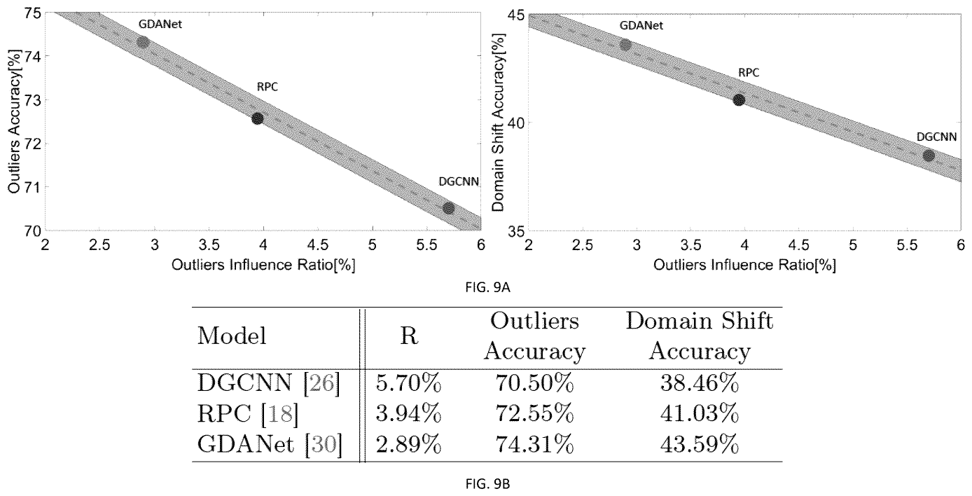

Reference is now made to FIG. 9 which depicts correlation between OOD influence measure 170OOD (R) and OOD accuracy, according to some embodiments of the invention. FIG. 9 includes panel 9A depicting a scatter plot illustrating the correlation between OOD influence measure 170OOD and accuracy for outliers and domain shift scenarios, and panel 9B depicting a table summarizing the quantitative data for various network architectures.

According to some embodiments, OOD influence measure 170OOD may be averaged over an entire corrupted dataset (e.g., add-global set) across all degrees of severity. As shown in FIG. 9, as the network tends to allocate more influence to the outliers, the overall performance may drop. A linear dependency may be observed between the fraction of influence (R) allocated to outliers and OOD robustness. Networks may be trained on a synthetic dataset (e.g., ModelNet40) and evaluated on corrupted data (e.g., ModelNet-C) representing outliers, as well as on real-world data (e.g., ScanObjectNN) representing domain shift.

According to some embodiments, domain shift may be another aspect of OOD evaluation, involving training on one domain and assessing performance on another. In this scenario, networks may be trained on a synthetic dataset (e.g., ModelNet40) and their performance may be evaluated on a more challenging real-world dataset (e.g., ScanObjectNN). The real-world dataset may encompass real-world point clouds often affected by challenging conditions, including outliers and complex backgrounds. Measuring the fractional influence (i.e., OOD influence measure 170OOD) may indicate efficiency for domain shift scenarios.

According to some embodiments, as shown in FIG. 8 (bottom row), certain network architectures (e.g., GDANet) may grasp relevant shape details in the presence of real-world challenges, making them well-suited for domain shift tasks compared to other examined networks. To quantitatively evaluate this insight, accuracy may be assessed on a shared class (e.g., Chair class) that is a category shared between the synthetic dataset and the real-world dataset. As shown in FIG. 9, the results may support a consistent trend, where the resilience of certain network architectures (e.g., GDANet) to outliers may align with their effectiveness in handling domain shifts, outperforming other network architectures (e.g., RPC and DGCNN). Networks allocating less influence to outlier points may exhibit superior robustness to both out-of-distribution outliers and domain shift scenarios.

According to some embodiments, aggregation values 160AV computed according to embodiments of the invention may be employed to analyze supervised and self-supervised learning methods. In image classification, prior studies have illustrated distinctions in influence maps derived from both supervised and self-supervised paradigms, even when applied to identical architectural configurations. For example, in the case of certain Vision Transformer architectures trained in a supervised manner, the acquired influence maps may manifest a tendency to attend to features not directly associated with the predicted object. For instance, an image featuring a cow surrounded by grass may generate an influence map attending both the cow and the surrounding grass. This phenomenon, denoted as shortcuts or spurious cues, may be attributed to dataset bias. The training dataset may predominantly feature instances of cows against a grassy backdrop, leading the classifier to erroneously associate the presence of the cow with the concurrent existence of a grassy background. In contrast, influence maps derived from Vision Transformer architectures trained under a self-supervised regime may exhibit a greater concentration on the predicted object.

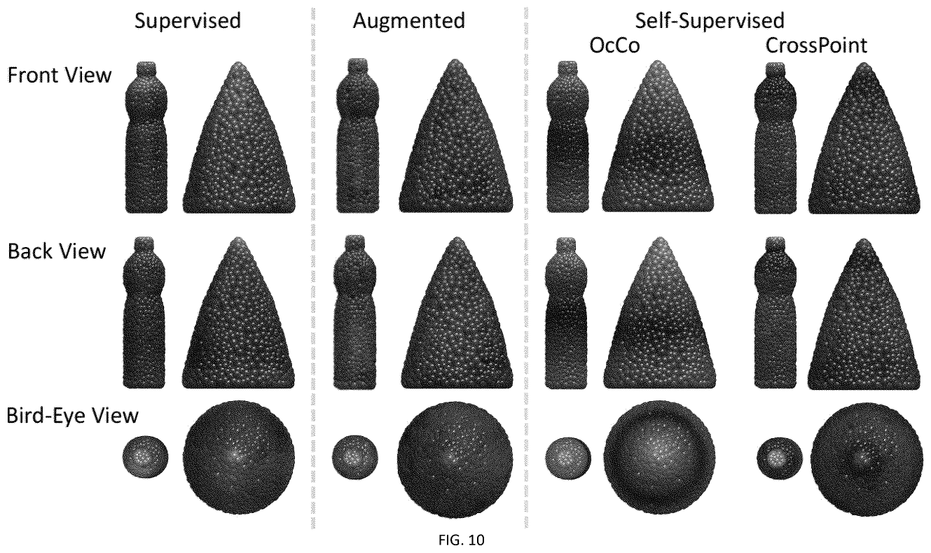

Reference is now made to FIG. 10 which is an illustration of influence on supervised and self-supervised methods, according to some embodiments of the invention. As shown in FIG. 10, all methods may utilize a common backbone architecture (e.g., DGCNN). The supervised approach may exhibit asymmetric influence, emphasizing the frontal aspect despite the symmetry of the shape (e.g., a bottle and a cone). In self-supervised methods (e.g., OcCo and CrossPoint), the influence may be symmetric, suggesting a potential dataset bias in the supervised approach. An augmented version may slightly alleviate the asymmetry but may depend on the augmentation procedure.

According to some embodiments, dataset bias may be explored using influence maps produced by self-supervised methods. For example, a first self-supervised method (e.g., CrossPoint) may learn 3D features by minimizing contrastive loss on image-to-point-cloud correspondences. A second self-supervised method (e.g., OcCo—Occlusion Completion) may focus on reconstructing obscured regions from a camera view. To ensure a fair comparison, a common backbone framework (e.g., DGCNN) may be employed for all methods.

According to some embodiments, unraveling spurious cues in certain datasets (e.g., ModelNet40) may present a challenge as all data points may be inherent to the object itself, lacking a distinct background. However, for objects characterized by symmetry, a corresponding symmetrical influence may be anticipated. As shown in FIG. 10, influence maps may be compared for objects featuring z-axis symmetry (e.g., a bottle and a cone). Evaluation of the influence map from a network trained in a supervised fashion may reveal a bias toward the frontal region of the object, resulting in an asymmetric influence on a symmetric shape. In contrast, with self-supervised methods (e.g., OcCo and CrossPoint), the influence measure may exhibit symmetry. The influence, when cultivated through a self-supervised approach, may align more symmetrically with the inherent symmetry of the object. The effect of augmentation may also be analyzed. Symmetry may be increased with augmentation; however, remains of asymmetry may still be present, since this approach may depend on the augmentation procedure.

According to some embodiments, this phenomenon may be attributed to dataset bias. For instance, if a majority of cups in the dataset have handles positioned at the frontal aspect, the network may disproportionately focus on this region in its pursuit of discriminative elements. In a self-supervised setting, where labels may be absent, there may be a potential reduction in susceptibility to such biases. Accordingly, based on a qualitative indication of dataset bias (as described herein with respect to symmetry influence measure 170MSI), system 10 may provide training feedback 180 for retraining feature extraction model 120 and/or classification model 150 using a self-supervised learning approach, augmented training data, or combinations thereof, so as to reduce susceptibility to dataset bias.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of explainable classification of a target point cloud by at least one processor, the method comprising:
receiving a target point cloud comprising a plurality N of points in a multidimensional space;
applying a feature extraction model on the target point cloud to extract, for each point of the N points, a respective permutation-invariant feature vector comprising a plurality of local feature entries;
applying a bottleneck function on the permutation-invariant feature vectors of the N points to produce a global feature vector having a plurality F of global feature entries;
applying a classification model on the global feature vector to classify the target point cloud according to one or more classification criteria;
for one or more points of the N points, applying an aggregation function over the local feature entries of the respective permutation-invariant feature vector, prior to the bottleneck function, to obtain a respective aggregation value; and
indicating importance of the one or more points in said classification based on their respective aggregation values.

2. The method of claim 1 wherein a total number of local feature entries across the N points exceeds the number of global feature entries F by at least one order of magnitude.

3. The method of claim 1, wherein the bottleneck function comprises a pooling function that aggregates the permutation-invariant feature vectors across the N points along a points dimension to produce the global feature vector.

4. The method of claim 3, wherein the pooling function is selected from a list consisting of: (i) a maximum pooling function, (ii) a mean pooling function, and a combination thereof.

5. The method of claim 4, wherein the bottleneck function is further selected from (iii) a weighted pooling function applied on values of corresponding local feature entries of the permutation-invariant feature vectors, (iv) a dense artificial Neural Network (NN) bottleneck layer applied on the permutation-invariant feature vectors, (v) a NN convolutional layer applied on the permutation-invariant feature vectors, and any combination thereof.

6. The method of claim 1, wherein applying the aggregation function of a specific point of the N points comprises at least one of: (i) summing local feature entries of that point, (ii) summing absolute values of local feature entries of that point, (iii) performing a weighted sum of local feature entries of that point, (iv) applying a predetermined function on a majority of local feature entries of that point, and any combination thereof.

7. The method of claim 1, wherein indicating importance of the one or more points comprises at least one of: (i) ranking the one or more points according to their respective aggregation values; (ii) generating an influence map associating each of the one or more points with a respective aggregation value; (iii) identifying a subset of points having aggregation values above a predetermined threshold as high-importance points; (iv) providing a visualization of the target point cloud wherein the one or more points are visually distinguished based on their respective aggregation values; (v) providing online feedback during inference of the classification model based on the respective aggregation values, and any combination thereof.

8. The method of claim 1, further comprising:
applying a rotation transformation to the target point cloud to produce a rotated point cloud;
for one or more points of the N points: (a) applying the feature extraction model on the rotated point cloud to extract a respective rotated permutation-invariant feature vector having a plurality of local feature entries, (b) applying the aggregation function over the local feature entries of the respective rotated permutation-invariant feature vector, prior to the bottleneck function, to obtain a respective rotated aggregation value, and (c) computing a pointwise deviation measure based on a difference between the respective aggregation value and the respective rotated aggregation value; and
providing a qualitative indication of rotation invariance of the feature extraction model and/or classification model based on the pointwise deviation measure.

9. The method of claim 8, further comprising:
calculating a shape deviation measure based on pointwise deviation measures of the one or more points of the target point cloud; and
based on the shape deviation measure, providing feedback for retraining the classification model and/or the feature extraction model, so as to improve rotation invariance.

10. The method of claim 1, further comprising:
identifying a set of outlier points within the target point cloud, wherein the outlier points are out-of-distribution (OOD) points not present during training of the feature extraction model;
computing a OOD influence measure as a ratio of a sum of aggregation values of the outlier points to a sum of aggregation values of all points in the target point cloud; and
providing a qualitative indication of OOD robustness of the feature extraction model and/or classification model based on the OOD influence measure, wherein a higher OOD influence measure is indicative of lower OOD robustness.

11. The method of claim 10, further comprising:
comparing the OOD influence measure to a predetermined threshold; and
based on the comparison, providing feedback for retraining the feature extraction model and/or classification model to reduce influence allocated to outlier points, so as to improve OOD robustness.

12. The method of claim 1, further comprising:
identifying a geometric symmetry property of the target point cloud;
analyzing a distribution of the aggregation values across the target point cloud to determine a symmetry influence measure;
comparing the symmetry influence measure to the geometric symmetry property; and
providing a qualitative indication of dataset bias in training data used to train the feature extraction model and/or classification model based on the comparison.

13. The method of claim 12, further comprising:
based on the qualitative indication of dataset bias, providing feedback for retraining the feature extraction model and/or classification model using at least one of: (i) a self-supervised learning approach, (ii) augmented training data, and any combination thereof, so as to reduce susceptibility to dataset bias.

14. A system for explainable classification of a target point cloud, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive a target point cloud comprising a plurality N of points in a multidimensional space;
apply a feature extraction model on the target point cloud to extract, for each point of the N points, a respective permutation-invariant feature vector comprising a plurality of local feature entries;
apply a bottleneck function on the permutation-invariant feature vectors of the N points to produce a global feature vector having a plurality F of global feature entries;
apply a classification model on the global feature vector to classify the target point cloud according to one or more classification criteria;
for one or more points of the N points, apply an aggregation function over the local feature entries of the respective permutation-invariant feature vector, prior to the bottleneck function, to obtain a respective aggregation value; and
indicate importance of the one or more points in said classification based on their respective aggregation values.

15. The system of claim 14, wherein the bottleneck function includes a pooling function that aggregates the permutation-invariant feature vectors across the N points along a points dimension to produce the global feature vector.

16. The system of claim 15, wherein the pooling function is selected from a list consisting of: (i) a maximum pooling function, (ii) a mean pooling function, (iii) a weighted pooling function applied on values of corresponding local feature entries of the permutation-invariant feature vectors, (iv) a dense artificial Neural Network (NN) bottleneck layer applied on the permutation-invariant feature vectors, (v) a NN convolutional layer applied on the permutation-invariant feature vectors, and any combination thereof.

17. The system of claim 14, wherein applying the aggregation function of a specific point of the N points includes at least one of: (i) summing local feature entries of that point, (ii) summing absolute values of local feature entries of that point, (iii) performing a weighted sum of local feature entries of that point, (iv) applying a predetermined function on a majority of local feature entries of that point, and any combination thereof.

18. The system of claim 14, wherein the at least one processor is further configured to:
apply a rotation transformation to the target point cloud to produce a rotated point cloud;
for one or more points of the N points: (a) apply the feature extraction model on the rotated point cloud to extract a respective rotated permutation-invariant feature vector having a plurality of local feature entries, (b) apply the aggregation function over the local feature entries of the respective rotated permutation-invariant feature vector, prior to the bottleneck function, to obtain a respective rotated aggregation value, and (c) compute a pointwise deviation measure based on a difference between the respective aggregation value and the respective rotated aggregation value; and
provide a qualitative indication of rotation invariance of the feature extraction model and/or classification model based on the pointwise deviation measure.

19. The system of claim 14, wherein the at least one processor is further configured to:
identify a set of outlier points within the target point cloud, wherein the outlier points are out-of-distribution (OOD) points not present during training of the feature extraction model;
compute an OOD influence measure as a ratio of a sum of aggregation values of the outlier points to a sum of aggregation values of all points in the target point cloud; and
provide a qualitative indication of OOD robustness of the feature extraction model and/or classification model based on the OOD influence measure, wherein a higher OOD influence measure is indicative of lower OOD robustness.

20. A method of analyzing rotation invariance of a point-cloud classification network by at least one processor, the method comprising:
receiving a target point cloud comprising a plurality N of points in a multidimensional space;
applying a feature extraction model on the target point cloud to extract, for each point of the N points, a respective permutation-invariant feature vector comprising a plurality of local feature entries;
for one or more points of the N points, applying an aggregation function over the local feature entries of the respective permutation-invariant feature vector to obtain a respective aggregation value;
applying a rotation transformation to the target point cloud to produce a rotated point cloud;
for the one or more points, applying the feature extraction model on the rotated point cloud and applying the aggregation function to obtain a respective rotated aggregation value;
computing a pointwise deviation measure based on a difference between the respective aggregation value and the respective rotated aggregation value; and
providing a qualitative indication of rotation invariance of the feature extraction model based on the pointwise deviation measure.
